(19) United States
(12) Patent Application Publication
(10) Pub. No.: US 2023/0294095 A1
(43) Pub. Date: Sep. 21, 2023

(54) FINE OBJECT SEPARATION DEVICE AND FINE OBJECT SEPARATION METHOD USING FINE OBJECT SEPARATION DEVICE

(71) Applicants: UNIST(ULSAN NATIONAL INSTITUTE OF SCIENCE AND TECHNOLOGY), Ulsan (KR); INDUSTRY-UNIVERSITY COOPERATION FOUNDATION HANYANG UNIVERSITY ERICA CAMPUS, Anyang-si, Gyeonggi-do (KR)

(72) Inventors: Taesung KIM, Ulsan (KR); Kyunghun LEE, Ulsan (KR); Jong Wook HONG, Seoul (KR); Kyusoon SHIN, Anyang-si, Gyeonggi-do (KR)

(73) Assignees: UNIST(ULSAN NATIONAL INSTITUTE OF SCIENCE AND TECHNOLOGY), Ulsan (KR); INDUSTRY-UNIVERSITY COOPERATION FOUNDATION HANYANG UNIVERSITY ERICA CAMPUS, Ansan-si, Gyeonggi-do (KR)

(21) Appl. No.: 18/017,856

(22) PCT Filed: Jul. 26, 2021
(86) PCT No.: PCT/KR2021/009606

§ 371 Date: Jan. 25, 2023

(30) Foreign Application Priority Data
Jul. 27, 2020 (KR) 10-2020-0092953

(51) Int. Cl. B01L 3/00

(52) U.S. Cl. CPC B01L 3/502753; B01L 2200/025; B01L 2200/0652; B01L 2300/0864

(57) ABSTRACT

A fine object separation device includes: a first channel in which a subject solution including a plurality of different fine objects having a size of 1 micrometer or less flows in from one side and flows to the other side; and a second channel that communicates with a first wall surface of the first channel at an angle greater than 0°, parallel to the flow direction of the subject solution, and less than 90°, perpendicular to the flow direction of the subject solution, wherein the second channel merges a buffer solution with the first channel.

### TECHNICAL FIELD

The present invention relates to a fine object separation device and a fine object separation method using the fine object separation device, and more particularly, to a fine object separation device in which smaller objects included in a solution flowing inside a channel are separated into a portion closer to a portion to which a buffer solution is supplied, and a fine object separation method using the fine object separation device.

### BACKGROUND ART

Particle separation is a technique for understanding complex and heterogeneous properties. For example, research on blood components has been developed with the development of blood separation techniques to identify typical blood components and specific bioparticles. However, there are still many problems to be solved, and one of the increasing problems is the separation of nanometer-sized extracellular vesicles from various body fluids, such as urine and saliva. In particular, exosomes are a type of extracellular vesicles and contain meaningful markers (miRNAs and proteins) that contain cellular information about diseases, so exosomes can be applied as disease markers including cancer in non-invasive diagnosis. Still, conventional vesicle separation techniques such as centrifugation, precipitation and size exclusion chromatography have their own limitations. These techniques have a problem in that they cannot secure the original shape or function of the vesicles after a separation process. In addition, techniques such as pinched-flow fractionation (PFF) are unsuitable for separating nanoparticles and submicron particles due to rapid diffusion.

### DETAILED DESCRIPTION OF THE INVENTION

### Technical Problem

The present invention provides a fine object separation device in which smaller objects included in a solution flowing inside a channel are separated into a portion closer to a portion to which a buffer solution is supplied, and a fine object separation method using the fine object separation device.

### Technical Solution

According to an aspect of the present invention, there is provided a fine object separation device including: a first channel in which a subject solution including a plurality of different fine objects having a size of 1 micrometer or less flows in from one side and flows to the other side; and a second channel that communicates with a first wall surface of the first channel at an angle greater than 0°, parallel to a flow direction of the subject solution, and less than 90°, perpendicular to the flow direction of the subject solution, wherein the second channel merges a buffer solution with the first channel, wherein the buffer solution supplied through the second channel separates the fine objects according to size in a direction intersecting with the flow direction of the subject solution, and the fine objects are separated such that the smaller fine objects are disposed closer to the first wall surface and the larger fine objects are disposed closer to a second wall surface that is spaced apart from and facing the first wall surface.

According to another aspect of the present invention, there is provided a fine object separation method using a fine object separation device, the fine object separation method including: a subject solution flowing step in which a subject solution including a plurality of different fine objects having a size of 1 micrometer or less flows in a first channel; a buffer solution merging step in which a buffer solution merges into the first channel through a second channel that communicates with a first wall surface of the first channel at an angle greater than 0°, parallel to a flow direction of the subject solution, and less than 90°, perpendicular to the flow direction of the subject solution; and a fine object separating step in which the buffer solution supplied through the second channel separates the fine objects according to size in a direction intersecting with the flow direction of the subject solution, and the fine objects are separated such that the smaller fine objects are disposed closer to the first wall surface and the larger fine objects are disposed closer to a second wall surface that is spaced apart from and facing the first wall surface.

According to another aspect of the present invention, there is provided a fine object separation method using a fine object separation device, the fine object separation method including: a subject solution flowing step in which a subject solution including a plurality of different fine objects having a size of 1 micrometer or less flows in a first channel and a buffer solution flows in a second channel that merges by forming an acute angle in the first channel; and a fine object separating step in which the buffer solution separates the fine objects according to size in a direction intersecting with the flow direction of the subject solution, and the fine objects are separated such that the larger fine objects are disposed far from the second channel.

According to another aspect of the present invention, there is provided is a fine object separation method using a fine object separation device, the fine object separation method including: a subject solution flowing step in which a subject solution including a plurality of different fine objects having a size of 1 micrometer or less flows in a first channel and vertical component forces are provided in a flow direction of the subject solution; and a fine object separating step in which the fine objects are separated according to size in a direction intersecting with a direction in which the subject solution flows, by the vertical component forces and the fine objects are separated such that the larger fine objects are disposed far from the vertical direction.

### Effects of the Invention

A fine object separation device and a fine object separation method using the fine object separation device according to the present invention have the following effects.

First, different nano-sized fine objects can be easily separated according to size using only a simple device.

Second, the relative size of the discharged fine objects can be predicted by changing a position where a buffer solution is supplied.

Third, the original shape or function of the fine objects can be maintained without being damaged after a separation process.

### DESCRIPTION OF THE DRAWINGS

FIG. 1 is a cross-sectional view of a fine object (particle) separation device according to an embodiment of the present invention.

FIG. 2 is a schematic diagram showing a state in which fine particles having a size exceeding 1 micrometer are separated using the fine object (particle) separation device shown in FIG. 1.

FIG. 3 is a schematic diagram showing a state in which fine particles having a size of less than 1 micrometer are separated using the fine object (particle) separation device shown in FIG. 1.

FIG. 4 is a schematic view showing a state in which fine particle separation efficiency is improved by forming a temperature gradient when fine particles are separated using the fine object separation device shown in FIG. 1.

FIG. 5 is an experimental graph showing simulation results obtained by quantifying the distribution of fine particles according to the size of fine particles in the fine object separation device shown in FIG. 1.

FIG. 6 is an experimental graph showing a state in which the relative ratio of fine particles discharged through a plurality of outlets can be visually checked by using a fluorescent dye in the fine object separation device shown in FIG. 1.

FIG. 7 is an experimental graph showing results obtained by separating exosomes including extracellular vesicles by using the fine object separation device shown in FIG. 1.

### MODE OF THE INVENTION

Hereinafter, the present invention will be described in detail by describing exemplary embodiments of the present invention with reference to the accompanying drawings.

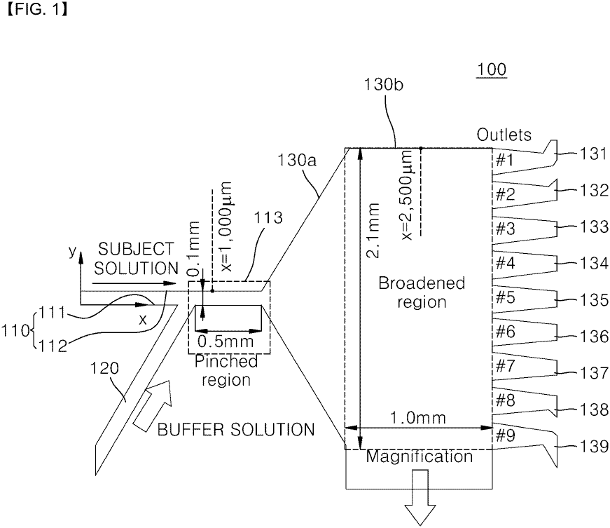

Referring to FIGS. 1 through 4, a fine object separation device 100 according to an embodiment of the present invention includes a first channel 110, a second channel 120, and an output channel 130. In the present embodiment, the fine objects include fine particles or bio-molecules such as endoplasmic reticulum. Hereinafter, the fine particles will be mainly described. A subject solution including different fine particles flow through a flow space inside the first channel 110. In this case, in the present embodiment, the case where the subject solution flows in from a left side that is one side of the first channel 110 to a right side that is the other side of the first channel 110, will be exemplified. Of course, any flow direction of the subject solution may be changed.

A ‘channel’ in the present embodiment means a fine passage or conduit through which injected fluids flow. In the present invention, the cross-sectional (a direction perpendicular to a fluid flow direction) shape of the channel may be selectively changed according to manufacturing convenience or as desired by those skilled in the art, and the present invention is not limited thereto, but the cross-sectional shape of the channel may include, for example, a circle, an ellipse, a rectangle, a square, or the like. In the present embodiment, the first channel 110 has a hollow therein and has a rod shape with a diameter of 0.1 mm.

As shown in FIG. 1, the first channel 110 according to the present embodiment is arranged horizontally along the x-axis direction (a direction in which the fine objects flow). However, the present invention is not limited thereto, and the diameter or shape of the first channel 110 may be changed. In addition, in the present embodiment, the fine particles mean particles having a size of 1 micrometer or less. That is, the fine particles are fine particles having a size of 1 micrometer or less of particles having nano-size or particles having micrometer size.

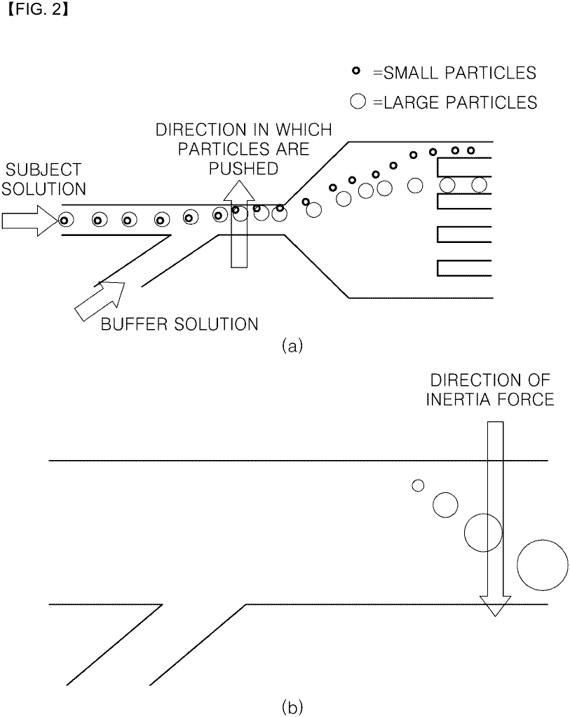

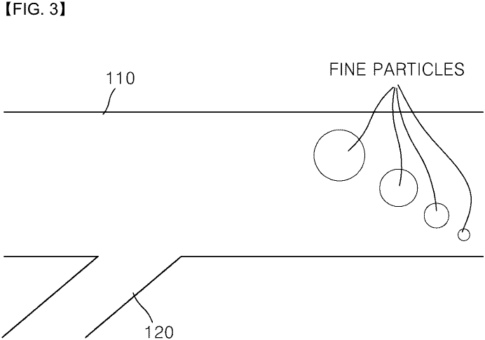

A pinched flow region 113 is formed from a portion communicating with the second channel 120 to a portion communicating with the output channel 130 in the first channel 110. In the present embodiment, the case where the pinched flow region 113 has a length of 0.5 mm, is exemplified. Of course, the length of the pinched flow region 113 may be changed. Referring to FIG. 2, the pinched flow means a phenomenon in which, when a fluid with a buffer solution is put in a fluid with particles through a thin channel, the fluids are pinched together, and when particles flow into a wide room (or a space or a wide conduit) by passing through the thin channel, position of the particles are determined according to their diameters. Thus, in a process of separating fine particles larger than 1 micrometer, large particles are separated closer to a side where the buffer solution merges, and small particles are separated far from the side where the buffer solution merges. This is referred to as pinched flow fractionation (PFF). However, referring to FIG. 3, in the present invention, contrary to FIG. 2, small particles are separated closer to the side where the buffer solution merges, and large particles are separated far from the side where the buffer solution merges. That is, according to the present invention, in addition to pinch flow fractionation, fine particle separation by the reverse action of pinch flow fractionation may be performed together, and this may be referred to as inverse pinched flow fractionation (IPFF).

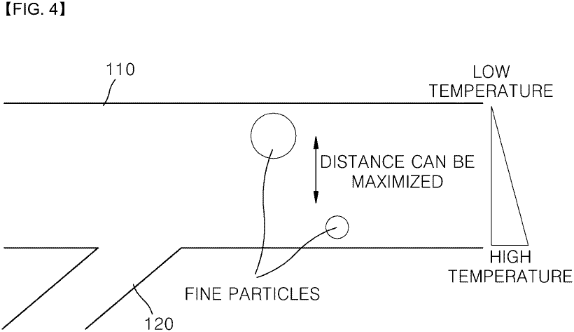

Referring to FIG. 4, a temperature gradient is formed in the first channel 110 by using a peltier device. This is to perform more efficient separation of fine particles having different sizes flowing through the first channel 110 by forming the temperature gradient in the first channel 110. In the present embodiment, the temperature gradient formed in the first channel 110 is formed in a transverse direction with respect to flow in which the subject solution flows. That is, in the present embodiment, the case where a temperature gradient in which temperature decreases as it gets closer to a second wall surface 112 from a first wall surface 111, is formed, will be exemplified. However, the present invention is not limited thereto, and other devices except for the peltier device may also be used to form a temperature gradient in the first channel 110.

In addition, the temperature gradient may be changed according to a position where the second channel 120 communicates with the first channel 110. That is, in the present embodiment, because the second channel 120 is formed to communicate with the first wall surface 111, the first wall surface 111 has a high temperature, and the second wall surface 112 has a low temperature, but when the second channel 120 is formed to communicate with the second wall surface 112, a temperature gradient is formed so that the second wall surface 112 has a high temperature and the first wall surface 111 has a low temperature. The ‘temperature gradient’ means that temperature in a solvent changes continuously or stepwise, and has a similar meaning to a temperature gradient or the like.

In the present embodiment, the first channel 110 is manufactured using photolithography. In this case, the first channel 110 is formed of polydimethylsiloxane (PDMS) material. Of course, the manufacturing method and material of the first channel 110 may be changed.

The subject solution means a solution that contains a plurality of fine particles having different sizes to be separated. That is, the subject solution is a suspension that contains fine particles having different sizes of 1 micrometer or less. Thus, the subject solution contains fine particles having at least two different sizes.

The second channel 120 communicates with the first channel 110. In the present embodiment, a lower flat surface of the first channel 110 is referred to as a first wall surface 111, and an upper flat surface of the first channel 110 is referred to as a second wall surface 112. The first wall surface 111 and the second wall surface 112 mean surfaces disposed in a position where they face each other. The second channel 120 communicates with the first wall surface 111. In this case, in the present embodiment, the second channel 120 communicates with the first wall surface 111 at an angle inclined about 45° with respect to the x-axis direction that is a direction in which the subject solution flows. Of course, the present invention is not limited thereto, and as long as the angle at which the second channel 120 communicates with the first wall surface 111 is greater than 0° and smaller than 90° (i.e., an acute angle), angle change is possible. This is to allow the buffer solution to provide vertical component forces to the direction in which the subject solution flows, when the buffer solution merges into the first channel 110 at an acute angle. The fine objects may be separated by the vertical component forces according to size in a direction intersecting with the direction in which the subject solution flows, and as the size of the fine object increases, the fine object may be separated so as to be located far from the vertical direction.

The buffer solution merges into the first channel 110 through an inside of the second channel 120. The buffer solution means a solution in which, when a certain amount of acid or base is applied from the outside, the solution is not greatly affected and maintains a constant hydrogen ion concentration (pH). In the present embodiment, the buffer solution flows in the first channel 110 and simultaneously serves to transport and separate the fine particles. Of course, as long as the buffer solution does not affect a film structure of the fine particles, the type of the buffer solution is not limited. For example, phosphate buffer saline (PBS), a PBS solution that contains sucrose, a PBS solution that contains glycine, or the like may be used as the buffer solution.

The output channel 130 is an outlet through which the fine particles contained in the subject solution merging with the buffer solution are classified according to size and discharged. The output channel 130 includes an inclined portion 130a, a horizontal portion 130b, and discharge portions 131 to 139. In the present embodiment, one side of the inclined portion 130a is connected to the other side of the first channel 110. At this time, a lower portion of the inclined portion 130a extends obliquely downwards from the first wall surface 111, and an upper portion of the inclined portion 130a extends obliquely upwards from the second wall surface 112. That is, the output channel 130 has a larger width than the first channel 110 due to the inclined portion 130a.

One side of the horizontal portion 130b is connected to the other side end of the inclined portion 130a. At this time, a lower side of the horizontal portion 130b is connected to a lower side of the inclined portion 130a and extends in the x-axis direction parallel to the first wall surface 111, and an upper side of the horizontal portion 130b is connected to an upper side of the inclined portion 130a and extends in the x-axis direction parallel to the second wall surface 112. In other words, the horizontal portion 130b is similar to the structure of the first channel 110 having an enlarged width. In the present embodiment, the case where the lower side and the upper side of the horizontal portion 130b face each other and at this time, a length at which the lower side and the upper side of the horizontal portion 130b face each other and are spaced apart from each other, is 2.1 mm, is exemplified. That is, in the present embodiment, the width of the output channel 130 is 20 times larger than the width of the first channel 110. In the present embodiment, the case where the extending length of the horizontal portion 130b is 1.0 mm, is exemplified.

The discharge portions 131 to 139 are portions in which the fine particles flowing through the inclined portion 130a and the horizontal portion 130b of the output channel 130 are separated according to size and are discharged. A plurality of discharge portions 131 to 139 are formed in a direction intersecting with the direction in which the subject solution flows. In the present embodiment, the case where nine outlets 131 to 139 are formed to be spaced apart from each other downwards sequentially from a first outlet 131 connected to the upper side of the horizontal portion 130b to a ninth outlet 139 connected to a lower side of the horizontal portion 130b, is exemplified. However, the present invention is not limited thereto, and the number of the outlets may be changed.

In the present embodiment, by making the output channel 130 wider than the first channel 110, the inclined portion 130a enables the fine particles that pass through the pinched flow region 113 of the first channel 110 and move to the output channel 130 to be efficiently separated in a vertical direction (y-axis direction) according to their size. The horizontal portion 130b enables the fine particles that are separated according to size while passing through the inclined portion 130a, to be stably discharged through the first outlet 131 to the ninth outlet 139 while moving in a horizontal direction (x-axis direction).

In the present embodiment, the outlets of the discharge portions 131 to 139 have the same size. That is, each outlet of the discharge portions 131 to 139 is formed to have at least a size that allows the largest fine particles to be discharged, but all have the same size. However, the present invention is not limited thereto, and sizes of the outlets of the discharge portions 131 to 139 may be different. That is, the size may be decreased from the first outlet 131 to the ninth outlet 139.

This is in consideration of the fact that fine particles having a smaller size are discharged from the first outlet 131 toward the ninth outlet 139. In this way, even if the fine particles, which are large in size and need to be discharged toward the first outlet 131, flow toward the ninth outlet 139, the fine particles are prevented from being discharged, thereby preventing exceptional errors that may occur in a fine particle separation process. In the present embodiment, because large fine particles are discharged from the first outlet 131 and small fine particles are discharged from the ninth outlet 139, the case where the sizes of outlets are decreased from the first outlet 131 to the ninth outlet 139, is exemplified, but the sizes of the outlets may be different from those of the present embodiment according to a position where the second channel 120 communicates with the first channel 110.

In addition, the outlets have the same lengths, and this is to make resistance to be discharged to the outlet the same. If the lengths of the outlets are not the same, a lot of the solution escapes to the side with less resistance, which can act as an error factor.

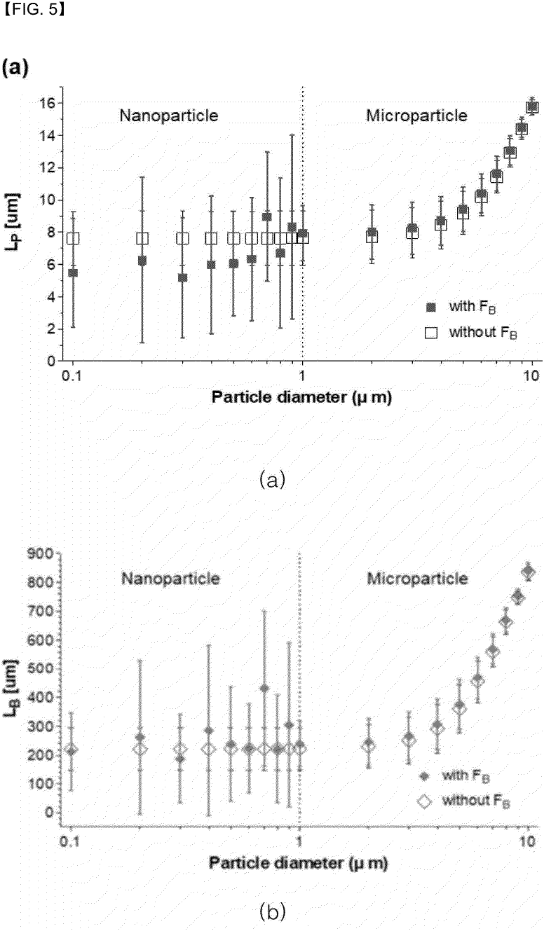

Referring to FIGS. 1 and 5, FIG. 5 is an experimental graph showing simulation results obtained by quantifying the length at which the fine particles are spaced apart from the second wall surface 112 of the first channel 110 in the pinched flow region 113 and the horizontal portion 130b of the output channel 130 according to the sizes of the fine particles flowing in the fine object separation device 100 according to the present embodiment. When the sizes of the fine particles in the pinched flow region L_{P} 113 are larger than 1 micrometer, the inertial force of the fine particles acts in proportion to particle size and thus, as the sizes of the fine particles increase, the fine particles are located closer to the first wall surface 111 of the first channel 110 in which the buffer solution merges. The fine particles enter the output channel 130 having the increasing width and then are discharged through the discharge portions 131 to 139. In this procedure, because the fine particles are greatly affected by the inertial force than the effect F_{B} due to Brownian force, as the sizes of the fine particles increase, the fine particles are located far from the second wall surface 112. That is, the fine particles are located closer to the first wall surface 111 in which the buffer solution merges.

On the other hand, when the size of fine particles is smaller than 1 micrometer, for the fine particles, the Brownian force dominates over other forces. That is, when the Brownian force is considered, the smaller the size of the nanoparticles, the larger the influence of the Brownian force than the inertial force, so that the nanoparticles are located closer to the first wall surface 111 of the first channel 110 where the buffer solution merges. That is, as the diameter of the fine particles decreases from 10 micrometers to 100 nanometers, the separation position of the fine particles changes, and it can be seen that the separation position of the fine particles greatly depends on the size of the fine particles. In particular, it can be seen that arrangement orders of the particles are different in the y-axis direction when the size of the fine particles is smaller than 1 micrometer and larger than 1 micrometer.

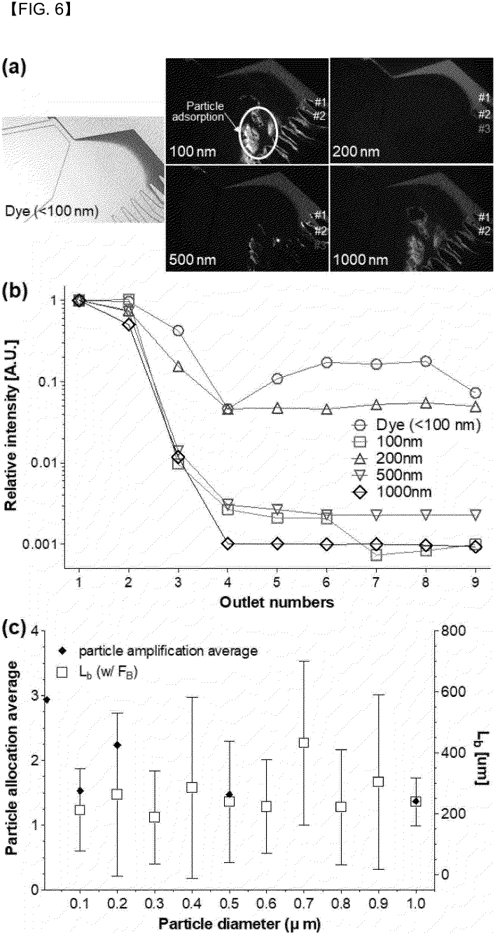

Referring to FIGS. 1 and 6, FIG. 6 shows an experimental result in which the relative ratio of the fine particles discharged through a plurality of outlets is visually checked by using a fluorescent dye in the fine object separation device 100. In the present experiment, polystyrene particles (samples) are used as the fluorescent dye. At this time, fine particles having sizes of 100, 200, 500 and 1000 nanometers are suspended in distilled water and flowed through the first channel 110. Magnification is 80 µl/min. In the present experiment, a blue dye is used to check the flow of the subject solution. The fluorescent dye polystyrene particles mainly pass through the first outlet 131, the second outlet 132, and the third outlet 133. For numerical comparison, the number of fine particles is quantified by the difference in fluorescence emission or adsorption intensity of samples collected through the discharge portions 131 to 139. The intensity of the first outlet 131 is set to 100%, and the relative intensity is calculated as shown in (b). Comparing the theoretically simulated result of (c) with the experimentally verified result, the similarity of the separation pattern of the fine particles is confirmed.

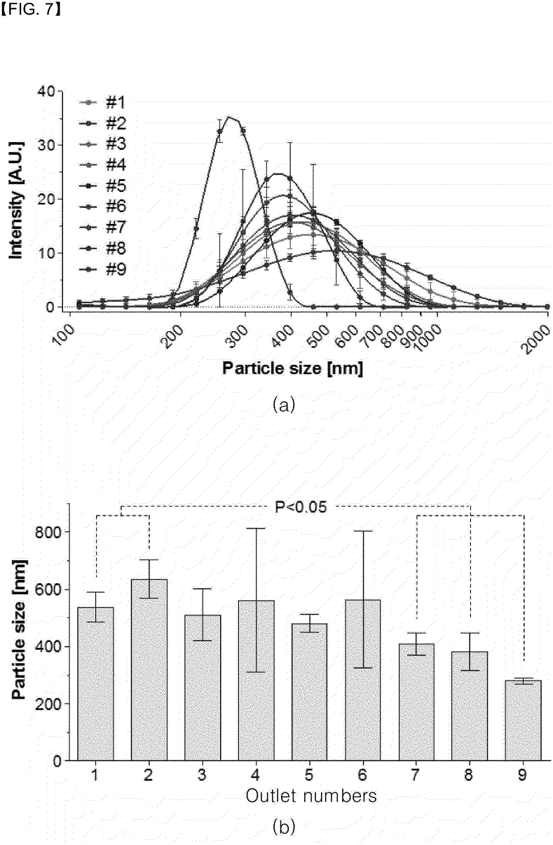

Referring to FIGS. 1 and 7, FIG. 7 is an experimental graph showing results obtained by separating exosomes including extracellular vesicles by using the fine object separation device 100. First, nanovesicles are collected from the SW620 cancer cell culture medium, and the concentrated nanovesicle suspension is introduced into the first channel 110 of the fine object separation device 100. Samples discharged from each of the discharge portions 131 to 139 are evaporated using a dynamic light scattering (DLS) method to measure nanoparticle entrapment. Comparing the average diameter in (b), the size difference of the vesicles at each outlet is approximately 600 nanometers in the first outlet 131 and the second outlet 132, while the diameter of the vesicles of the seventh outlet 137 through the ninth outlet 139 is about 300 to 400 nanometers. Thus, it can be seen that the fine object separation device 1000 can be applied to biological samples of nanovesicles.

Hereinafter, a method of separating fine particles by using the fine object separation device 100 shown in FIG. 1 will be briefly described.

First, the subject solution including a plurality of fine particles having different sizes of less than 1 micrometer flows into the first channel 110. Next, the buffer solution merges into the first channel 110 through the second channel 120 communicating with the first channel 110 at an angle of 45° with respect to a direction in which the subject solution flows. Of course, as long as the angle of the second channel 120 communicating with the first channel exceeds 0° that is an angle parallel to the direction in which the subject solution flows and is less than 90° that is an angle perpendicular to the direction in which the subject solution flows, the angle of the second channel 120 communicating with the first channel may be changed. At this time, a temperature gradient is formed in the first channel 110 so that temperature decreases from the first wall surface 111 with which the second channel 120 communicates, to the second wall surface 112 facing the first wall surface 111.

Next, one side of the output channel 130 communicates with the other side of the first channel 110, and the subject solution flows into the output channel 130 having a larger channel width than the first channel 110. At this time, the fine particles pass through the pinched flow region 113 from the point where the buffer solution merges to a portion where the first channel 110 communicates with the output channel 130, and move along the inclined portion 130a of the output channel 130 having a large width so that the fine particles are separated according to size. The fine particles separated from the inclined portion 130a move along the horizontal portion 130b of the output channel 130 and are separated and discharged according to size through the first outlet 131 to the ninth outlet 139.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

By using the present invention, a fine object separation device can be manufactured.

1. A fine object separation device comprising:
a first channel in which a subject solution including a plurality of different fine objects having a size of 1 micrometer or less flows in from one side and flows to the other side; and
a second channel that communicates with a first wall surface of the first channel at an angle greater than 0°, parallel to a flow direction of the subject solution, and less than 90°, perpendicular to the flow direction of the subject solution, wherein the second channel merges a buffer solution with the first channel,
wherein the buffer solution supplied through the second channel separates the fine objects according to size in a direction intersecting with the flow direction of the subject solution, and the fine objects are separated such that the smaller fine objects are disposed closer to the first wall surface and the larger fine objects are disposed closer to a second wall surface that is spaced apart from and facing the first wall surface.

2. The fine object separation device of claim 1, further comprising an output channel having one side communicating with the other side of the first channel and having a larger channel width than the first channel.

3. The fine object separation device of claim 2, wherein the output channel comprises:
an inclined portion having one side communicating with the other side of the first channel, extending obliquely upwards from an upper surface of the first channel so that a width of the inclined portion becomes larger than the first channel and extending obliquely downwards from a lower surface of the first channel; and
a horizontal portion having one side communicating with the other side of the inclined portion and extending parallel to each of the first wall surface and the second wall surface.

4. The fine object separation device of claim 2, wherein the output channel comprises a plurality of outlets formed to be spaced apart from each other in a direction intersecting with a direction in which the subject solution flows, so that the fine objects are classified according to size and are discharged.

5. The fine object separation device of claim 1, wherein a temperature gradient in which temperature decreases from the first wall surface to the second wall surface, is formed in the first channel.

6. The fine object separation device of claim 1, wherein the fine objects comprise fine particles.

7. The fine object separation device of claim 1, wherein the fine objects comprise bio-molecules.

8. A fine object separation method comprising:
a subject solution flowing step in which a subject solution including a plurality of different fine objects having a size of 1 micrometer or less flows in a first channel;
a buffer solution merging step in which a buffer solution merges into the first channel through a second channel that communicates with a first wall surface of the first channel at an angle greater than 0°, parallel to a flow direction of the subject solution, and less than 90°, perpendicular to the flow direction of the subject solution; and
a fine object separating step in which the buffer solution supplied through the second channel separates the fine objects according to size in a direction intersecting with the flow direction of the subject solution, and the fine objects are separated such that the smaller fine objects are disposed closer to the first wall surface and the larger fine objects are disposed closer to a second wall surface that is spaced apart from and facing the first wall surface.

9. The fine object separation method of claim 8, wherein the fine object separation device further comprises an output channel having one side communicating with the other side of the first channel and having a larger channel width than the first channel.

10. The fine object separation method of claim 8, wherein the output channel comprises a plurality of outlets formed to be spaced apart from each other in a direction intersecting with a direction in which the subject solution flows, so that the fine objects are classified according to size and are discharged.

11. The fine object separation method of claim 8, wherein the fine object separating step further comprises forming a temperature gradient in which temperature decreases from the first wall surface to the second wall surface, in the first channel.

12. A fine object separation method comprising:
a subject solution flowing step in which a subject solution including a plurality of different fine objects having a size of 1 micrometer or less flows in a first channel and a buffer solution flows in a second channel that merges by forming an acute angle in the first channel; and
a fine object separating step in which the buffer solution separates the fine objects according to size in a direction intersecting with the flow direction of the subject solution, and the fine objects are separated such that the larger fine objects are disposed far from the second channel.

13. The fine object separation method of claim 12, wherein the fine object separating step further comprises forming a temperature gradient in which temperature decreases as it gets farther from the second channel with respect to a direction perpendicular to a flow direction of the subject solution, in the first channel.

14. A fine object separation method comprising:
a subject solution flowing step in which a subject solution including a plurality of different fine objects having a size of 1 micrometer or less flows in a first channel and vertical component forces are provided in a flow direction of the subject solution; and
a fine object separating step in which the fine objects are separated according to size in a direction intersecting with a direction in which the subject solution flows, by the vertical component forces and the fine objects are separated such that the larger fine objects are disposed far from the vertical direction.

15. The fine object separation method of claim 14, wherein the fine object separating step further comprises forming a temperature gradient in which temperature decreases as it gets farther from the vertical direction, in the first channel.
